(19) United States
(12) Patent Application Publication
(10) Pub. No.: US 2015/0086175 A1
(43) Pub. Date: Mar. 26, 2015

(54) INTEGRATED VIDEO AND AUDIO RECORDING AND TRANSMISSION

(71) Applicant: Mobile-Vision, Inc., Boonton, NJ (US)

(72) Inventor: Leo Lorenzetti, Hardyston, NJ (US)

(21) Appl. No.: 14/051,964

(22) Filed: Oct. 11, 2013

Related U.S. Application Data
(60) Provisional application No. 61/882,610, filed on Sep. 25, 2013.

(51) Int. Cl. H04N 5/77; B60R 1/00

(52) U.S. Cl. CPC H04N 5/77; B60R 1/00
USPC 386/226

(57) ABSTRACT

A device includes a body-worn camera and small form factor digital video recorder that is integrated with a wireless microphone and transmitter that interoperates with an in-car video system.

### STATEMENT OF RELATED APPLICATION

This application claims the benefit of provisional application No. 61/882,610 filed Sep. 25, 2013, the disclosure of which is incorporated by reference herein.

### BACKGROUND

Vehicle-mounted surveillance systems, also termed in-car video systems, are seeing increased use in the security industry and law enforcement community as an effective means to provide an indisputable video and audio record of encounters involving officers and citizens. In these systems, a video camera is typically mounted on the police car's dashboard or windshield and is generally arranged to have a field of view of the area to the immediate front of the car. The field of view approximately corresponds to what an officer would see when seated in the car's front seat. In-car video systems generally employ a wireless microphone carried on the person of a law enforcement officer to record an audio soundtrack that accompanies the visual scene captured on videotape. The audio soundtrack is an extremely valuable complement to the recorded video because it acts as a transcript of what was said, by whom and when. Video surveillance has expanded, in some cases, to include body-worn cameras that can record video and audio of an officer's interactions that may not otherwise be captured with other equipment.

This Background is provided to introduce a brief context for the Summary and Detailed Description that follow. This Background is not intended to be an aid in determining the scope of the claimed subject matter nor be viewed as limiting the claimed subject matter to implementations that solve any or all of the disadvantages or problems presented above.

### SUMMARY

A device includes a body-worn camera and small form factor digital audio/video recorder (“DVR”) that is integrated with a microphone and transmitter that interoperates with an in-car video system. The body of the integrated device includes a wireless mobile transmitter as well as functional components that interoperate with a vehicle docking station. When the integrated device is docked, it is synchronized with the in-car system's vehicle-mounted DVR so that audio subsequently captured by the microphone can be wirelessly transmitted to the vehicle docking station and relayed to a vehicle-mounted video recorder for recording. The vehicle docking station also provides power to charge a rechargeable battery in the integrated device that can power various parts of the device including the body-worn camera, small form factor DVR, and the wireless microphone and transmitter. Functional components are also included in the body of the device that interoperate with an office docking station to enable device charging as well as uploading of video captured by the body-worn camera and recorded by the small form factor DVR to an external system for remote storage and viewing.

In various illustrative examples, the microphone, camera, and small form factor DVR are located in a separate camera head that is operatively and removably attachable to the body of the integrated device. The integrated device with the attached camera head may be clipped to an article of clothing such as a shirt in various locations so that the body-worn camera is positioned at an appropriate vantage point to capture and record scenes in the proximity of the device user. Alternatively, the camera head may be detached from the body of the integrated device by the user and then separately clipped to the user's clothing to provide an appropriate vantage point for the camera while the body of the device is positioned at another location such as the user's belt. The user will operatively tether the camera head to the device body using a signal cable in this latter case.

The integrated device may be alternatively arranged to operate independently from the in-car video system or dependently on the in-car video system. When operated independently, the integrated device operates as a standalone video recorder (using the small form factor DVR) which selectively records audio/video captured by the body-worn camera and audio captured by the microphone in response to user actuation of controls, such as buttons, located on the camera head. When operated dependently on the in-car video system, the integrated device may be configured so that user actuation of the controls will cause two video recordings to be initiated—one by the small form factor DVR in the integrated device and the other by the vehicle-mounted DVR. Both of the video recordings will typically include the audio captured by the microphone located in the integrated device. However, in some implementations, it may be desirable to record captured audio in the small factor DVR only and not transmit the audio back to the in-car video system. Such feature of elimination of audio transmission from the integrated device to the in-car video system may be configured to be selectively utilized in some cases.

A delayed recording feature may be implemented for the small form factor DVR in the integrated device when it is operated dependently on the in-car video system. This features delays the start of the video recording on the integrated device once the in-car video system starts recording, for example, upon activation of the vehicle's lights and/or sirens. However, a trigger signal is sent to the integrated device when the in-car video system starts recording so that audio is captured by the microphone in the integrated device, transmitted to the in-car video system, and recorded. Upon expiration of some predetermined time interval (which can be configurable) after the vehicle stops moving (as determined by an evaluation of GPS (Global Positioning System) data from a GPS functionality provided in the in-car system), another trigger signal is sent to the integrated device to start the recording of the body-worn small form factor DVR. This delayed recording feature advantageously enables the digital data storage capabilities of the small form factor DVR in the integrated device to be more optimally utilized. For example, without the delayed recording feature, the body-worn camera could typically be expected to capture video of the steering wheel of the vehicle as the officer drives to an incident or scene. Such video generally has limited evidentiary value but could consume a significant amount of storage space and battery power particularly in applications in rural areas where the officer may be driving for relatively long periods of time before arriving at the incident or scene.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Furthermore, the claimed subject matter is not limited to implementations that solve any or all disadvantages noted in any part of this disclosure.

### DESCRIPTION OF THE DRAWINGS

FIG. 1 shows an illustrative law enforcement environment in which the present integrated video and audio recording and transmission may be implemented;

FIG. 2 is a block diagram showing various functional components that may be used to implement aspects of the present integrated video and audio recording and transmission;

FIG. 3 shows an illustrative functional block diagram of a camera head and mobile transmitter;

FIG. 4 shows an illustrative functional block diagram of a vehicle docking station;

FIG. 5 shows an illustrative functional block diagram of an office docking station;

FIG. 6 shows pictorial views of an illustrative device having an integrated wireless microphone and body-worn camera;

FIG. 7 shows pictorial views of an illustrative camera head;

FIG. 8 shows a pictorial view of an illustrative microphone-only head;

FIG. 9 shows a pictorial view of a camera head being detached from the mobile transmitter of an integrated device;

FIG. 10 shows a pictorial view of the camera head being tethered to a mobile transmitter of an integrated device using a signal cable with connectors at each end;

FIG. 11 shows various illustrative locations on the uniform of an officer to which a camera head may be attached;

FIG. 12 shows various illustrative locations on the uniform of an officer on which an integrated device may be located;

FIG. 13 shows pictorial views of a vehicle docking station;

FIG. 14 shows pictorial views of a vehicle docking station when an integrated device is docked;

FIG. 15 shows pictorial views of an office docking station; and

FIG. 16 is an illustrative block diagram showing video captured by a body-worn camera being uploaded to an agency digital evidence system when coupled to an office docking station.

Like reference numerals indicate like elements in the drawings. Elements are not drawn to scale unless otherwise indicated.

### DETAILED DESCRIPTION

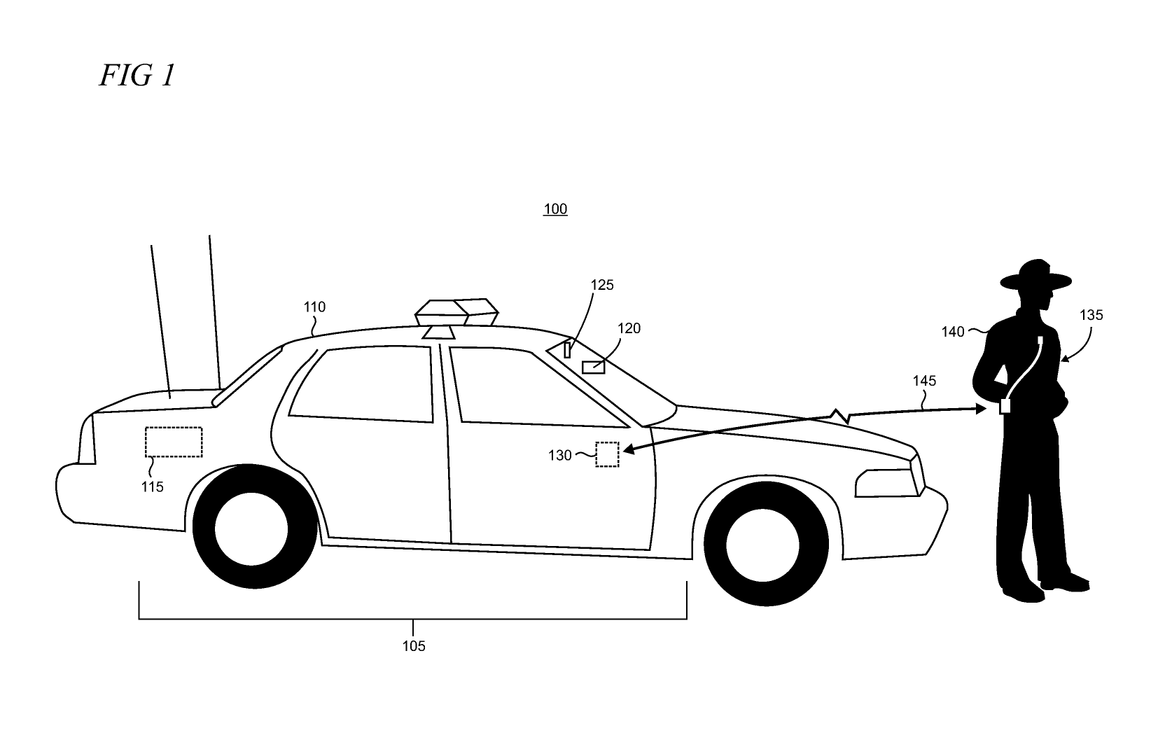

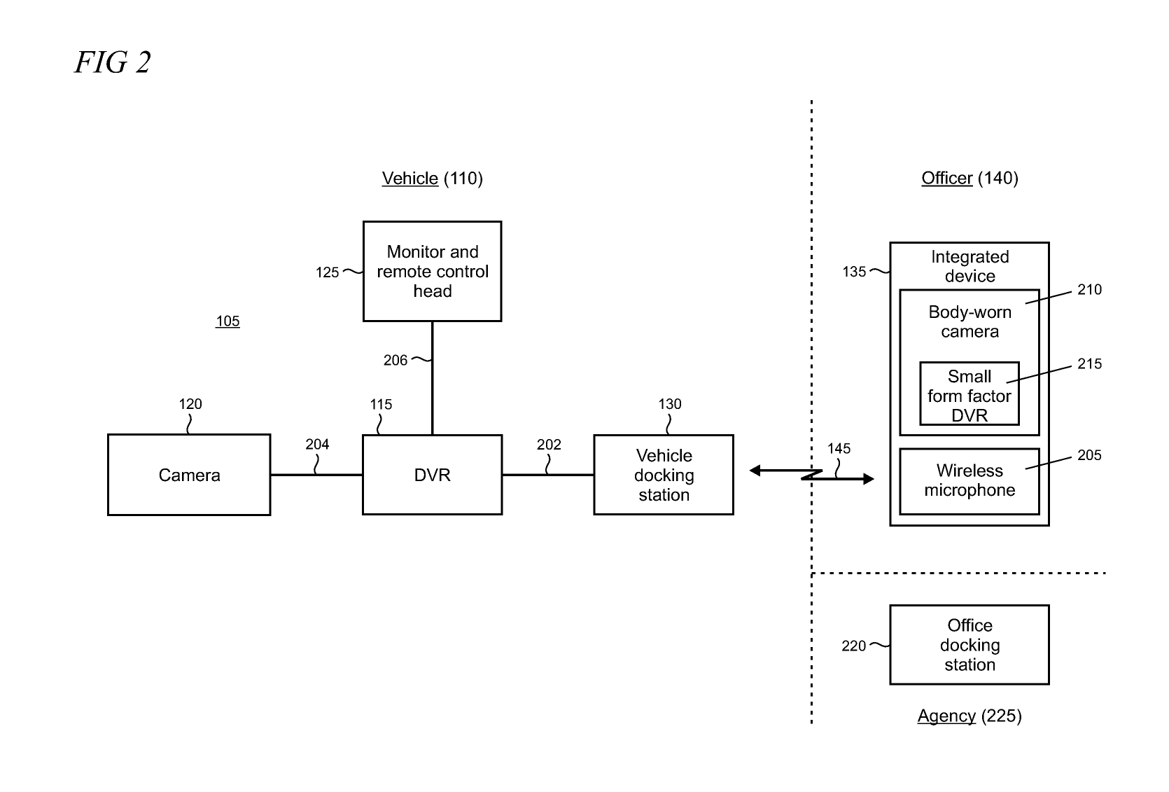

FIGS. 1 and 2 show an illustrative law enforcement environment 100 in which the present integrated video and audio recording and transmission may be implemented. While a law enforcement environment 100 is shown in FIGS. 1 and 2, it is emphasized that the features and benefits of the present integrated video and audio recording and transmission may also be applicable to a wide variety of applications beyond law enforcement. Applications to the security and transportation industries may be readily implemented, for example. Thus, the term “officer” in the description that follows can be understood to refer to the user or operator of various parts of the present invention in non-law enforcement applications.

An in-car video system 105 includes a number of components that are installed in various locations in a vehicle 110. The components include a recording device such as digital video recorder (“DVR”) 115, a camera 120, a monitor and remote control head 125, and vehicle docking station 130. As shown in this illustrative example, the DVR 115 is mounted in the trunk of the vehicle 110. The camera 120 is mounted on the interior of the windshield looking outward to capture scenes in front of the vehicle. The monitor and remote control head 125 is located towards the interior roof the vehicle near the rearview mirror (not shown). The vehicle docking station 130 is located within the interior of the vehicle 110, typically within reach of the officer when seated. The operative connections between the components in the in-car video system are shown in FIG. 2. A bus 202 couples the vehicle docking station 130 to the DVR 115, a bus 204 couples the camera 120 to the DVR 115, and a bus 206 couples the monitor and remote control head 125 to the DVR 115.

The locations of the components of the in-car video system are typical, but can vary from that shown in FIG. 1 depending on the requirements of a given application. Additional components (not shown in FIG. 1) are also commonly utilized in various applications such as a vehicle-mounted microphone to capture audio within the interior of the vehicle 110 such as the back seat area. Additional cameras may also be utilized in some applications such as rearward facing cameras to capture scenes behind the vehicle 110 and cameras that can capture scenes within the vehicle.

The vehicle docking station 130 supports two-way (i.e., bi-directional communication with a mobile transmitter portion of an integrated device 135 worn by an officer 140 over a wireless link 145. The integrated device combines a wireless microphone 205 (FIG. 2) and body-worn camera 210 as described in more detail below. The body-worn camera 210 includes components that implement a small form factor DVR 215 that is capable of recording video and audio separate and apart from the vehicle-mounted DVR 115.

The bi-directional communication capabilities enable the wireless microphone 205 portion of the integrated device 135 to be automatically switched on (without the officer 140 having to manually operate a switch) when the DVR 115 starts recording so that audio is captured and transmitted back to the vehicle docking station 130 which in turn relays the audio to the DVR 115 to be recorded along with the video captured by the camera 120. For example the DVR 115 may start recording when the vehicle's emergency systems (e.g., lights and siren) are operated, speed-measuring radar or laser is operated, or when the vehicle exceeds a threshold speed. The automatic activation of the wireless microphone 205 may be implemented in accordance with the description in U.S. Pat. No. 7,119,832 issued on Oct. 10, 2006 and U.S. Pat. No. 8,446,469 issued on May 21, 2013, the disclosures of which are incorporated by reference herein.

An office docking station 220 (FIG. 2) is also present in the law enforcement environment 100, the functions of which are described in more detail below. The office docking station 220 is typically located in a facility at the law enforcement agency 225, such as a police department.

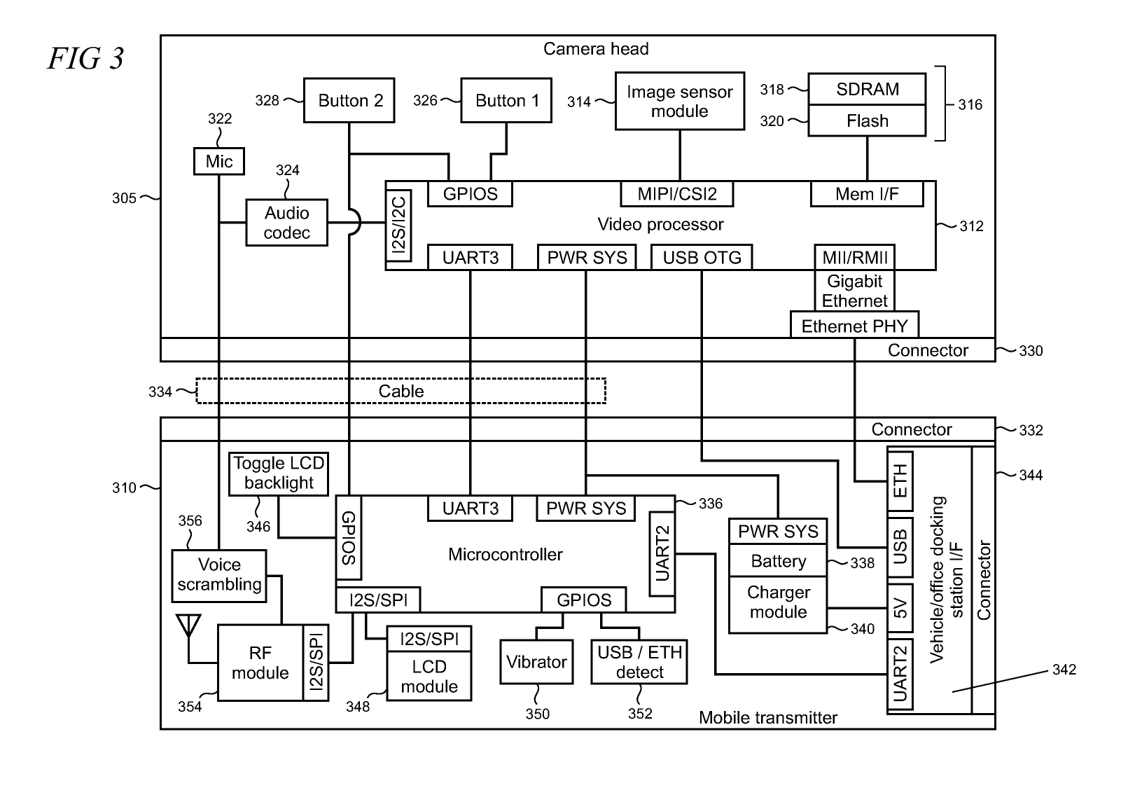

The integrated device 135 may be physically embodied using a camera head that is removably coupled to a mobile transmitter. FIG. 3 shows an illustrative functional block diagram of the camera head 305 and mobile transmitter 310. As shown, the camera head 305 includes a video processor 312 to which an image sensor module 314 is coupled via a MIPI/CSI2 (Mobile Industry Processor Interface/Camera Serial Interface 2) interface. The image sensor module 314 and video processor 312 may typically be configured to support high-definition (“HD”) video capture and processing at resolutions of 1280×720 pixels using progressive scanning (i.e., 720p) at a frame rate of 30 frames-per-second (30 fps). Typically, image stabilization is provided using post-processing so that raw captured images are not stabilized in order to maintain evidentiary value of the captured images.

The field of view of the optics portions of the image sensor module 314 can vary according to implementation. For example, a field of view (“FOV”) between 72 and 140 degrees can typically be specified.

Non-removable memory 316 comprising SDRAM (synchronous dynamic random access memory) 318 and Flash memory 320 is coupled via a memory interface (“I/F”) to the video processor 312. The memory 316 is typically specified to provide a minimum of four hours of continuous video and audio recording in typical implementations and enables approximately 8 hours of recorded video to be stored in the integrated device 135. However, it is emphasized that various amounts of storage capacity can be utilized depending on the requirements of a particular implementation of the present integrated video and audio recording and transmission.

A microphone 322 is disposed in the camera head 305 which captures audio that is processed by an audio codec 324. Processed audio is passed to the video processor 312 via an I2S/I2C (Integrated Interchip Sound/Inter-Integrated Circuit) interface.

Buttons 1 and 2, respectively indicated by reference numerals 326 and 328, are coupled to the video processor 312 via a GPIO (general purpose input/output) interface. The operation of button 1 326 is configured to turn on the video capture of the small form factor DVR 215 (FIG. 2) and enables a still snapshot to be captured with an additional press when the video capture is ongoing. Button 1 326 can also be utilized by the officer 140 to turn off video capture using a “press and hold” operation. For example, video capture can be turned off by pressing and holding the button for three seconds.

The operation of button 2 328 may be configured so that a single press turns on and off the RF (radio frequency) transmission of audio captured by the microphone over the wireless link between the mobile transmitter 310 and the vehicle docking station 130 (FIGS. 1 and 2).

In some cases, the button implementation on the camera head 305 is configured so that a button operation on the camera head will operate both the small form factor DVR as well as the vehicle mounted DVR 115 (FIGS. 1 and 2). Thus in this situation, the officer 140 can simultaneously initiate two separate video recordings from an operation of button 1 326—one video recording is captured using the small form factor DVR 215 in the body-worn camera 210 and a separate video recording is captured at the same time using the vehicle-mounted DVR 115. Similarly, button operation may be configured so that the press and hold operation turns off both the small form factor DVR in the body-worn camera and the vehicle-mounted DVR at the same time. It is noted that in some cases the two DVRs can record substantially the same scene from two different views or vantage points, while in other cases, the two DVRs will record different scenes altogether. However, a single audio track captured by the microphone 322 will typically accompany the videos recorded by each of the DVRs.

The camera head 305 includes interfaces that enable operative interaction with the mobile transmitter 310 as well as the vehicle and office docking stations 130 and 220. The operative interactions are facilitated through a physical coupling between the camera head 305 and the mobile transmitter 310 using respective mating connectors 330 and 332 or a signal cable 334. In this particular illustrative example, the connectors 330 and 332 are configured as 30 pin connectors.

As shown in FIG. 3, a UART3 (Universal Asynchronous Receiver/Transmitter) interface is included in each of the video processor 312 and a microcontroller 336 in the mobile transmitter 310. Likewise, power system interfaces are maintained in each of the video processor 312 and microcontroller 336. The power system interfaces enable a rechargeable battery 338 disposed in the mobile transmitter 310 to power the components in both the camera head 305 and mobile transmitter 310.

The battery 338 is typically configured to provide a minimum of four hours of continuous audio/video recording and simultaneous audio transmission over the wireless link 145 to the vehicle docking station 130 (FIGS. 1 and 2). The battery 338 can further typically provide a minimum of 12 hours of continuous audio transmission and 48 hours of standby operation. It is emphasized that different battery capacities can be provided depending on the requirements of a particular implementation of the present integrated video and audio recording and transmission. The battery 338 may be field replaceable in some implementations.

A charger module 340 is provided in the mobile transmitter 310 and 5V (volt) interface so that the battery 338 can be recharged when the integrated device is docked in either the vehicle docking station 130 or the office docking station 220. In typical applications, the battery 338 can be expected to be fully recharged in approximately two hours.

The video processor 312 further includes USB (Universal Serial Bus) and MII/RMII (Media Independent Interface/Reduced Media Independent Interface) interfaces for gigabit Ethernet that are implemented as a pass through in the mobile transmitter to a vehicle/office docking station interface 342 that is physically implemented using a connector 344 that interfaces with a mating connector in each of the vehicle docking station 130 and office docking station 220. In this illustrative example, the mating connectors in the mobile transmitter and docking stations are configured as 30 pin connectors. As shown, the vehicle/office docking station interface 342 provides the 5V charging interface, a USB interface, an Ethernet interface, and UART2 interface through the connector 344 to the vehicle docking station 130 and the office docking station 220.

The microcontroller 336 supports a GPIO interface to a toggle 346 to control a backlight to an LCD (liquid crystal display) 348. The LCD display 348 is coupled to the microcontroller 336 via an I2S/SPI (Integrated Interchip Sound/Serial Peripheral Interface) and may be configured to provide status messages to the officer 140. The status messages may include those shown in the Table below.

TABLE

| Status | |
|---|---|
| Message | Meaning |
| IN SYNC | The signal over the wireless link 145 between the |
| | integrated device 135 and the vehicle docking station |
| | 130 is good and the devices are synchronized (in typical |
| | implementations, approximately 3 km line of sight |
| | transmission range is provided, with approximately |
| | 2 km for non-line of sight/city transmission range). |
| MUTE ON | Audio capture is temporarily muted (i.e., disabled). |
| NO SYNC | The signal over the wireless link 145 between the |
| | integrated device 135 and the vehicle docking station |
| | is poor or non-existent. This typically occurs because |
| | the integrated device 135 is out of transmission range or |
| | there may be a barrier (e.g., a metal barrier) between |
| | the devices. A reconnection can be reestablished when |
| | the officer 140 places the integrated device 135 back in |
| | the vehicle docking station 130 to be resynchronized. |
| BATT LOW | The charge of the battery 338 is low. The battery 338 can |
| | be recharged when the officer 140 places the integrated |
| | device 135 back in the vehicle docking station 130. |
| DISCONNECT | The camera head 305 is unable to communicate with the |
| | mobile transmitter 310. This could occur, for example, |
| | because the physical connection between the mating |
| | connectors 330 and 332 is loose or dirty, or the physical |
| | connections between the cable 334 and either the camera |
| | head 305 and mobile transmitter 310 are loose or dirty. |

The microcontroller 336 in the mobile transmitter 310 also supports a GPIO interface to a vibrator 350 that is typically utilized to implement a vibrate mode that provides an alert to the officer 140 that eliminates audible “beeps” so as to provide increased officer safety in sensitive tactical situations. For example, the mobile transmitter 310 may vibrate once to indicate to the officer 140 that a recording has been successfully initiated and vibrate twice to indicate that a recording has been successful stopped. A USB/Ethernet detection module 352 is also coupled to the microcontroller 336 via the GPIO interface.

An RF module 354 is disposed in the mobile transmitter 310 and coupled to the microcontroller 336 via the I2S/SPI interface. The RF module 354 is operatively coupled through a voice scrambling module 356 to the microphone 322 in the camera head 305 when the camera head 305 is coupled to the mobile transmitter 310 (either through a direct connection or via the cable 334).

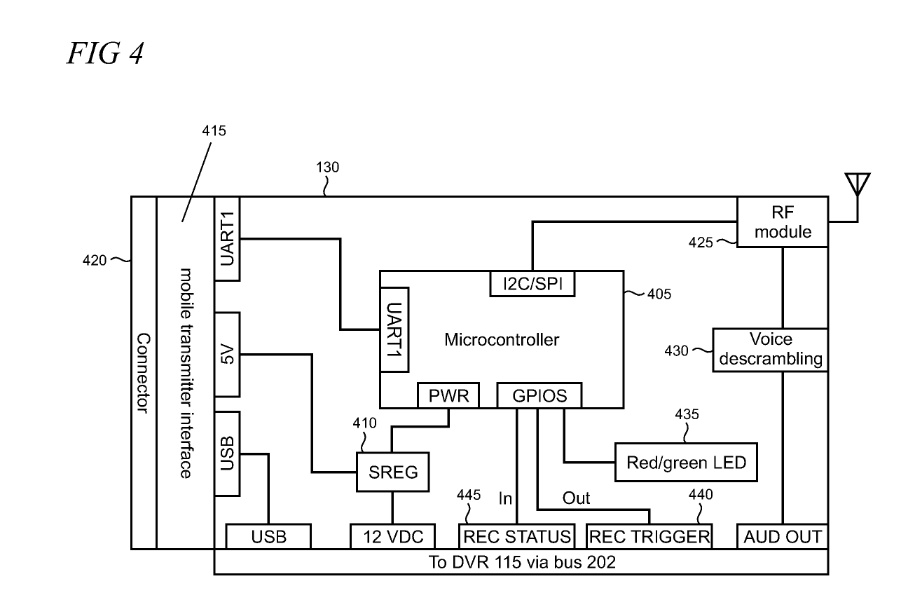

FIG. 4 shows an illustrative functional block diagram of the vehicle docking station 130. The vehicle docking station 130 includes a microcontroller 405 that is coupled via a power interface to a switching regulator 410 so that 12V power may be received via the bus 202 from the DVR 115. The switching regulator 410 also provides 5V power to the charger module 340 (FIG. 3) through the mobile transmitter interface 415 at the physical connector 420 which is configured to mateably engage with the connector 344 on the mobile transmitter 310. As with the connector 344, connector 420 may be configured as a 30 pin connector.

When the connectors 420 are 344 are engaged, the microcontroller 336 in the mobile transmitter 310 is operatively coupled to the microcontroller 405 in the vehicle docking station 130 via respective UART interfaces. The USB interface to the video processor 312 in the camera head 305 is also configured as a pass through in the vehicle docking station 130 to the DVR 115 via the bus 202. This pass through enables the video processor 312 to be operatively coupled to the DVR 115 when the connectors 420 and 344 are engaged when the integrated device 135 is docked in the vehicle docking station 130.

The microcontroller 405 supports an I2C/SPI interface to an RF module 425 that is configured for interoperation with the corresponding RF module 354 in the mobile transmitter 310. The RF module is coupled to a voice descrambling module 430 that enables audio received from the wireless microphone 205 of the integrated device 135 to be descrambled and then passed, via an audio out interface that is coupled to the bus 202, to the DVR 115 where it is recorded as a soundtrack to video that is captured by the in-car video system 105 (FIG. 1).

The microcontroller 405 supports a GPIO interface that enables a set of LEDs (light emitting diodes) 435, which can be configured to emit green or red light, to provide status indicators on the vehicle docking station 130. In typical implementations, one of the LEDs can indicate that the battery 338 (FIG. 3) is charging when red, and indicate that the battery is fully charged when green. Likewise another LED can be used to indicate synchronization status with the integrated device 135 when docked in the vehicle docking station 130. For example, if the synchronization indicating LED blinks four times and then stops, the officer 140 can take this as an indication that the integrated device 135 has just synchronized with the vehicle docking station. As described in U.S. Pat. Nos. 7,119,832 and 8,446,469, the process of synchronization between the wireless microphone and the vehicle docking station enables a frequency spreading code to be exchanged so that the RF transmission over the wireless link 145 is secure. In addition, the frequency spreading code exchange enables any integrated device in the equipment pool to work with any in-car video equipped vehicle in the agency's fleet.

Metadata may also be transmitted or exchanged during synchronization between the integrated device 135 and the vehicle docking station 130. The metadata may include a bi-directional exchange of device serial numbers, and transmission of officer name (typically obtained from the in-car video system 105), unit/vehicle number (from the in-car video system), and the current time/date (typically derived using the GPS (Global Positioning System) capabilities that may be included as part of the in-car video system) to the integrated device 135.

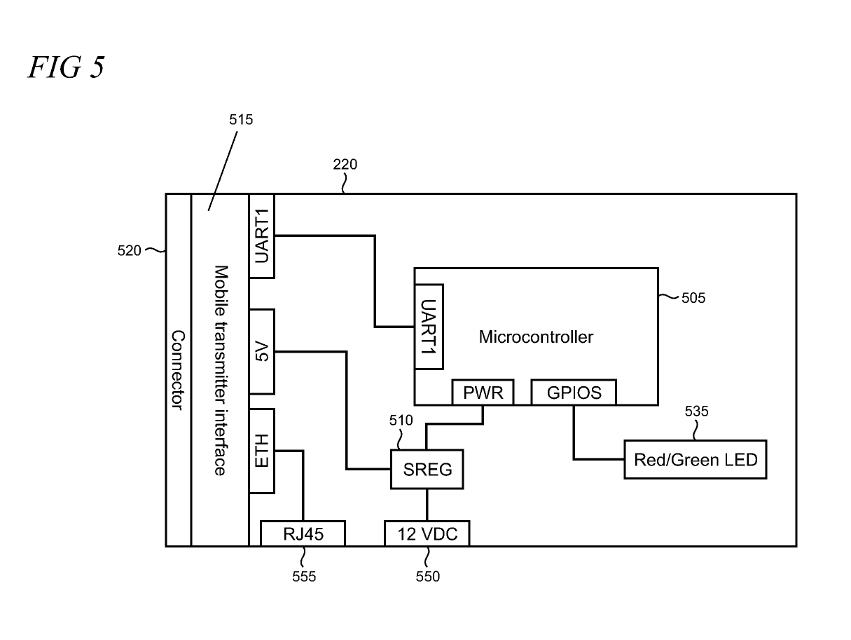

The metadata may also include a configuration file that can be downloaded to the integrated device when docked in either the vehicle docking station 130 or the office docking station described in the text accompanying FIG. 5 below. The configuration file may be utilized to ensure that the integrated device 135 has the desired settings in accordance with policies that are typically set by authorities in the agency. The configuration file can be maintained in an external system under the control of an administrator.

The metadata may be utilized to assist in the pairing of the captured videos once they are uploaded to an external system such as a digital evidence system, for example, as described in more detail below. By treating both the captured videos from vehicle-mounted DVR 115 and small form factor DVR 215 as a single event, the external system may be configured so that a search for a video will result in both videos being retrieved (as a single event). For example, if a user searches for video captured on a given date and within a range of times for a given officer, the user will typically want to see all the possible videos that meet the search criteria, not just videos captured by the vehicle-mounted DVR. Thus, the system can be configured to that if the user selects (i.e., “clicks”) on the vehicle video meeting the search criteria, that user will typically be made aware of or shown the video from the body-worn camera at the same time.

Continuing with the description of FIG. 4, if the second LED blinks continuously, for example, this may indicate to the officer 140 that the vehicle docking station is unable to synchronize with the integrated device 135. If the second LED shines continuously, for example, this may indicate to the officer 140 that audio is active (i.e., the wireless microphone is currently capturing audio which is being recorded by the DVR 115 in the in-car video system 105).

The microcontroller 405 in the vehicle docking station 130 also supports a GPIO interface that supports the output of a record trigger 440 to the DVR 115 via bus 202. The GPIO interface also supports receipt of recording status indicator 445 from the DVR 115. As described in U.S. Pat. Nos. 7,119,832 and 8,446,469, the record trigger 440 may be utilized to activate recording on the DVR 115. Thus, for example, the integrated device 135 may be used to remotely activate and deactivate the DVR 115 and start and stop a recording, for example, by operating button 1, as described above. The record status signal 445 may be utilized to remotely activate the wireless microphone 205 of the integrated device 135 when the DVR 115 is recording. Thus, for example, if the DVR 115 starts recording because the vehicle's emergency lights or siren have been activated, the record status signal 440 is generated by the DVR 115 and received by the microcontroller 405 over the bus 202 via the GPIO interface. The microcontroller 405 can then send a signal over the bi-directional wireless link 145 to trigger the wireless microphone 205 to capture audio which is relayed back to the vehicle docking station 130 via the wireless link to the RF module 420. The vehicle docking station 130, in turn, provides descrambled audio to the DVR 115 over the bus 202 for recording, as described above.

FIG. 5 shows an illustrative functional block diagram of the office docking station 220. The office docking station 220 includes a microcontroller 505 that is coupled via a power interface to a switching regulator 510 so that 12V power may be received from an external power supply (not shown) via a power input 550. The switching regulator 510 also provides 5V power to the charger module 340 (FIG. 3) through the mobile transmitter interface 515 at the physical connector 520 which is configured to mateably engage with the connector 344 on the mobile transmitter 310. As with the connector 344, connector 520 may be configured as a 30 pin connector.

When the connectors 520 and 344 are engaged, the microcontroller 336 in the mobile transmitter 310 is operatively coupled to the microcontroller 405 in the office docking station 220 via respective UART interfaces. The Ethernet interface to the video processor 312 in the camera head 305 is also configured as a pass through in the office docking station 220 to an Ethernet output port such as an RJ45 jack 555. This pass through enables the video processor 312 to be operatively coupled to an external system (as described in more detail below) when the connectors 420 and 344 are engaged when the integrated device 135 is docked in the office docking station 220.

The camera head 305 may also be directly docked in the office docking station 220 in some cases, that is, without being attached to the mobile transmitter 310, to enable the video processor 312 to be operatively coupled to the external system via the Ethernet interface. The camera head 305 may thus be configured with a connector (e.g., a 30 pin connector) that is mateably engagable with the connector 520 in the office docking station 220.

The microcontroller 505 supports a GPIO interface that enables a set of LEDs (light emitting diodes) 535, which can be configured to emit green or red light, to provide status indicators on the office docking station 130. In typical implementations, an LED can indicate that the battery 338 (FIG. 3) is charging when red, and indicate that the battery is fully charged when green.

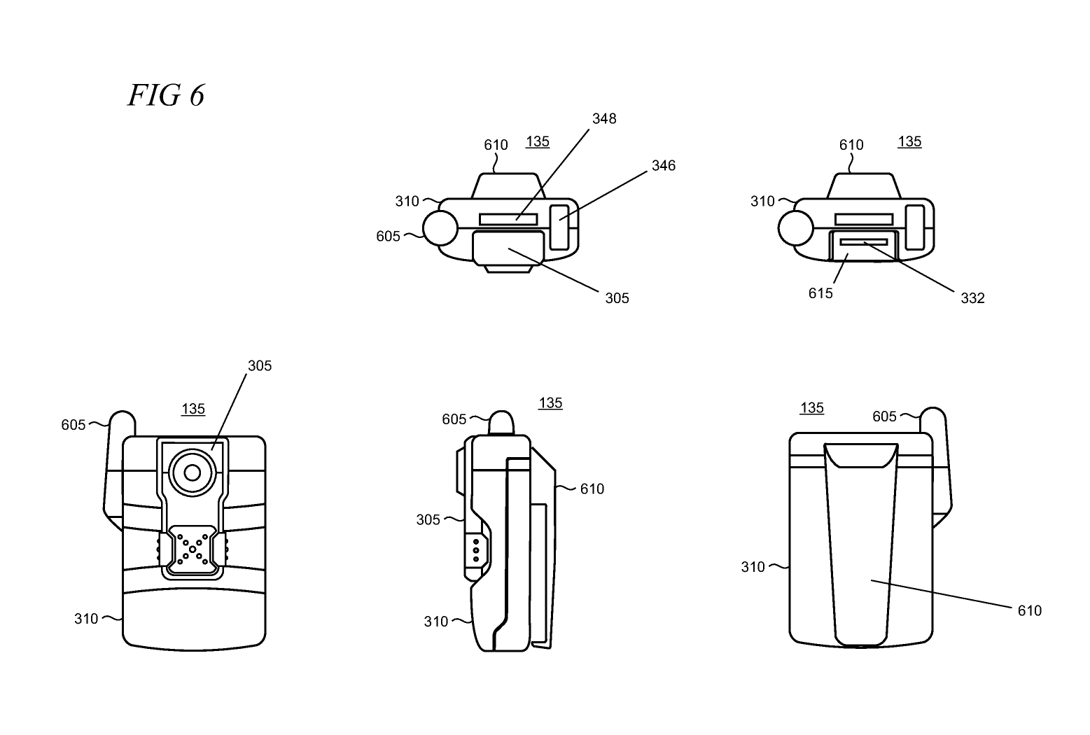

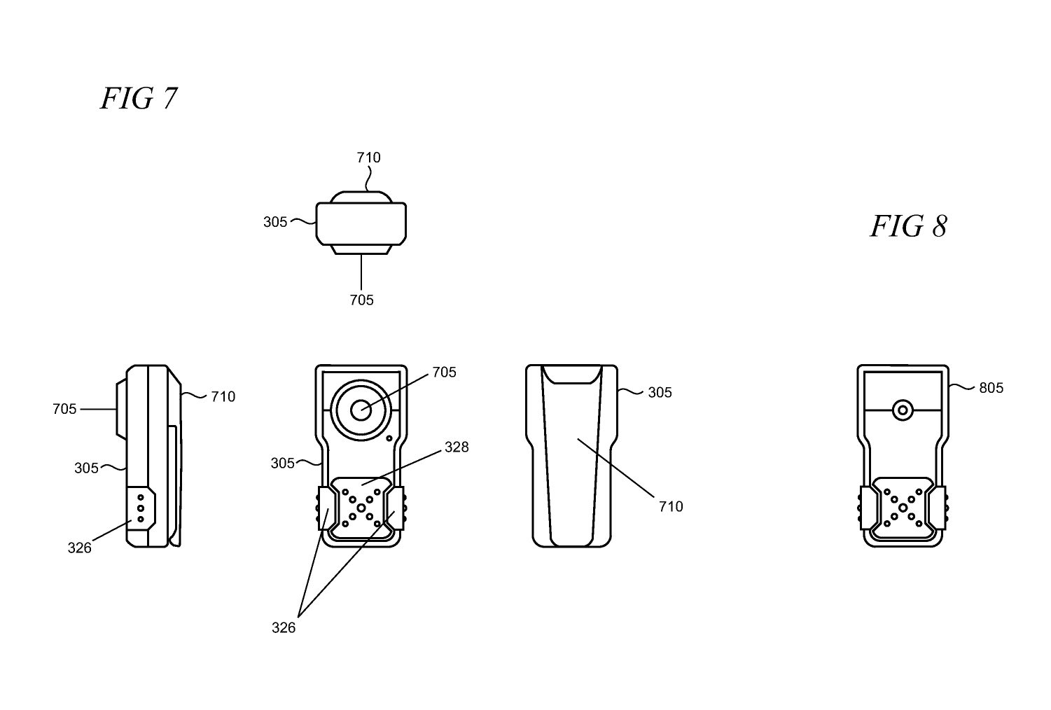

FIG. 6 shows illustrative pictorial views, including front, side, back, and top views of the integrated device 135 which includes a wireless microphone and body-worn camera functionalities. As described above, the integrated device 135 includes a camera head 305 and a mobile transmitter 310. The camera head 305 is packaged in housing that is configured to be removably attachable to the housing for the mobile transmitter 310. The camera head 305 is separately shown in FIG. 7 in front, side, back, and top views. The camera head 305 is configured to be easily removed from the mobile transmitter 310, without tools, but is securely held in place, for example by detents that are incorporated in the housings of either the camera head 305 or mobile transmitter 310 (or both) when attached to the mobile transmitter. When the camera head 305 is attached to the mobile transmitter 310, the connectors 330 and 332 (FIG. 3) are mateably engaged.

As shown in FIG. 6, the mobile transmitter 310 supports an external antenna 605. The LCD display 348 and backlight toggle 346 are located on the top of the mobile transmitter 310. A belt clip 610 is configured to enable the integrated device 135 to be conveniently clipped to the duty belt of the officer 140. The belt clip 610 may be configured in some implementations to be removably attachable. Alternatively, the belt clip 610 may be configured with a swivel or similar mechanism so that the integrated device 135 can be positioned with variable orientation on the duty belt or at another location on the officer's uniform, as described in more detail below.

The connector 332 is shown in the top view of the mobile transmitter 310 in FIG. 6. As shown, the connector 332 is located at the bottom of an area such as a recess 615 that is configured to hold the camera head 305 when it is attached to the mobile transmitter.

As shown in FIG. 7, the button 1 326 (FIG. 1) on the camera head 305 is physically implemented as a pair of actuators that are located below the camera objective 705. The actuators of button 1 326 are simultaneously pressed or squeezed by the officer's thumb and finger in order to implement the button 1 functionality to turn the video recording of the small form factor DVR 215 in the camera head 305 on and off and, in some implementations, also remotely turn the video recording of vehicle-mounted DVR 115 on and off. Using a pair of actuators for button 1 326 ensures that the DVRs are not inadvertently or accidently triggered to start or stop a video recording. Button 2 328 is implemented, in this illustrative example, as a single centrally located actuator. The connector 330 (not shown in FIG. 7) is disposed at the bottom of the camera head 305 and mateably engages with the connector 332 in the mobile transmitter 310 when the camera head is attached to the mobile transmitter.

A clip 710 is configured to enable the camera head, when detached from the mobile transmitter 310, to be conveniently clipped to a portion of the uniform of the officer 140. The clip 710 is typically configured to be removably attachable. Alternatively, the clip may be non-removably configured. In some implementations, the clip 710 may be configured with a swivel or similar mechanism so that the camera head 305 can be positioned at various locations on the officer's uniform, as described in more detail below.

FIG. 8 shows a pictorial view of an illustrative microphone-only head 805. The microphone-only head 805 is removably attachable to the mobile transmitter 310 in the same way as the camera head 305 and can interoperate with both the vehicle docking station 130 and office docking station 220. However, the microphone-only head does not include the functionality provided by the small form factor DVR 215.

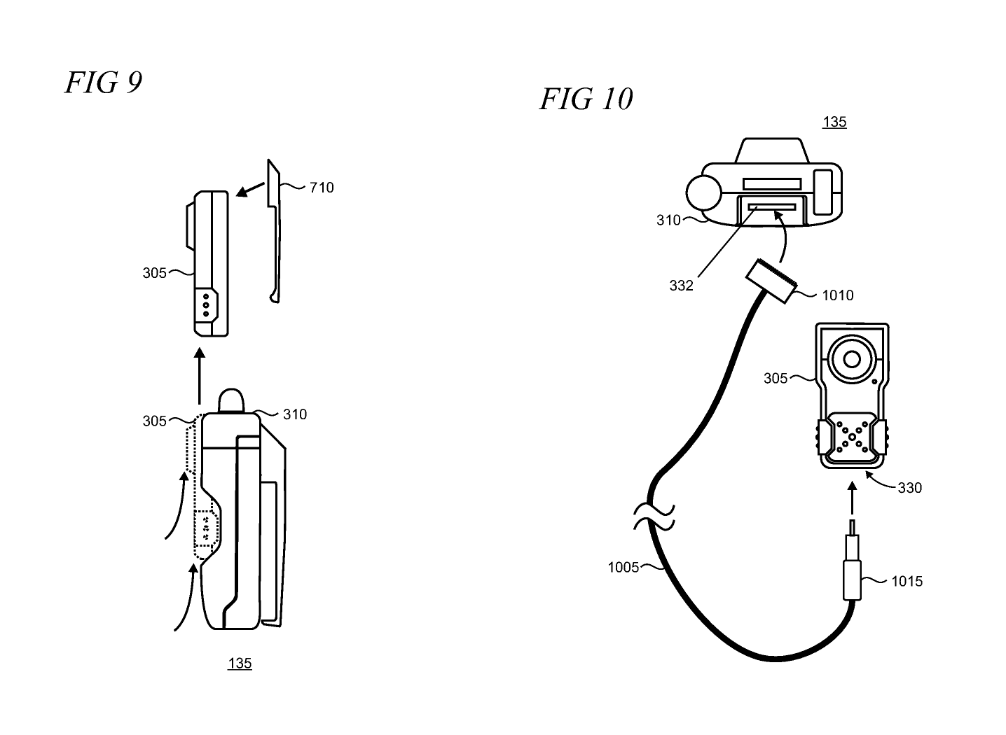

FIG. 9 shows a pictorial view of the camera head 305 being detached from the mobile transmitter 310 of the integrated device 135 in order to operate in a tethered mode. As shown, the camera head 305 is configured to slide upwards to be released from the recess in the mobile transmitter when pushed by the officer 140 at the bottom of the camera head or below the camera objective, for example, as indicated by the arrows. The clip 710 will typically be attached to the camera head 305 once the camera head is released from the mobile transmitter 310 (as noted above, in alternative embodiments, the clip is non-removable). As shown in FIG. 10, a signal cable 1010 may then be used to provide the requisite connectivity between the camera head 305 and mobile transmitter 310. Connectors 1010 and 1015 on either end of the signal cable 1005 are configured to mate with respective connectors 332 and 330 in the mobile transmitter 310 and camera head 305.

The cable 1005 may be configured in multiple different lengths depending upon application requirements. The cable 1005 is also typically arranged to break away from either the camera head 305 or mobile transmitter 310 under stress so as to not pose a choking hazard to the officer 140.

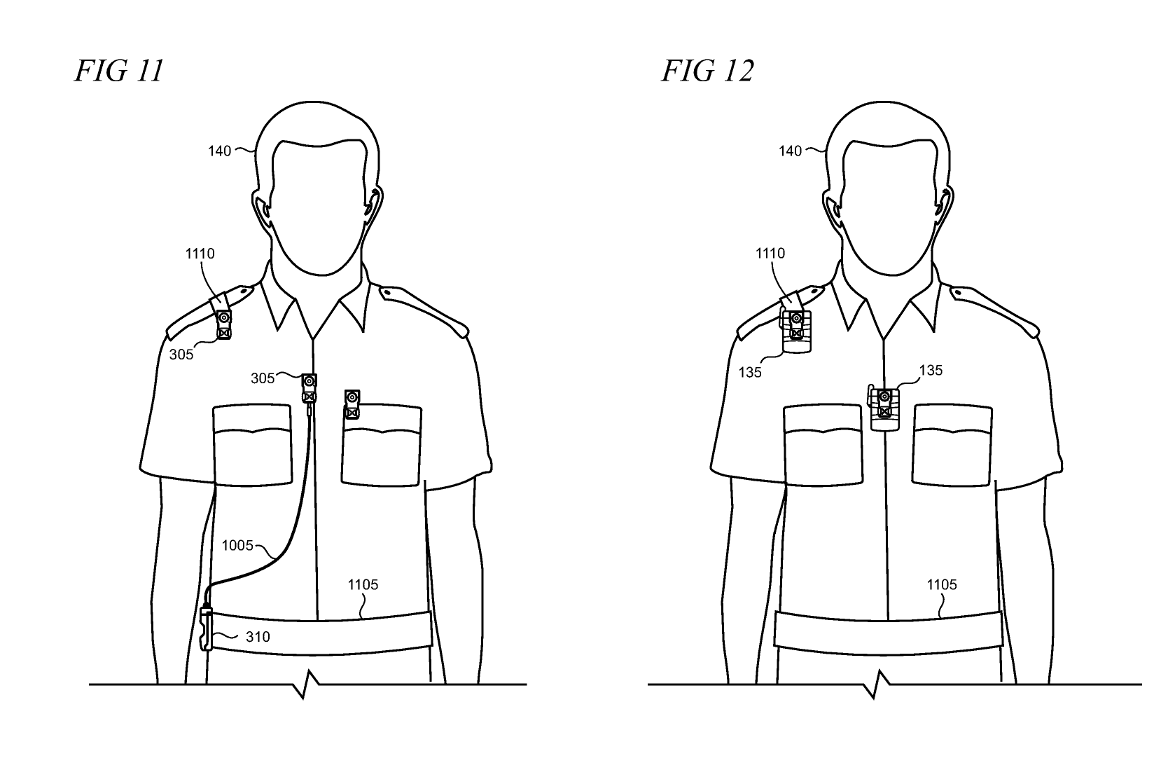

FIG. 11 shows various illustrative locations on the uniform of the officer 140 to which a camera head 305 may be clipped or attached when configured in the tethered mode. Here, the mobile transmitter 310 is clipped to the duty belt 1105 of the officer 140. The camera head 305 can then be clipped to the uniform shirt placket or shirt pocket, for example, as shown (only a single cable 1005 is shown for sake of clarity in FIG. 10, however it is noted that the camera head 305 needs to be connected to the mobile transmitter 310 via the cable 1005 in order to operate). By using a strap 1110 that loops around the shirt's epaulette (i.e., shoulder strap) with a hook and loop fastener, the camera head 305 may be located around the officer's shoulder area. It will be appreciated that the camera head 305 may also readily be clipped or attached to the shirt collar and other locations on the officer's uniform.

FIG. 12 shows various illustrative locations on the uniform of the officer 140 on which an integrated device 135 may be clipped or attached when not configured in the tethered mode. In this case, the clip 610 (FIG. 6) on the mobile transmitter 310 is used to clip to the officer's uniform. As shown in FIG. 12, the integrated device is shown clipped to the shirt placket or attached via the strap 1110 to the shirt's epaulette. It will be appreciated that the integrated device 135 may also readily be clipped or attached to the shirt collar and other locations on the officer's uniform.

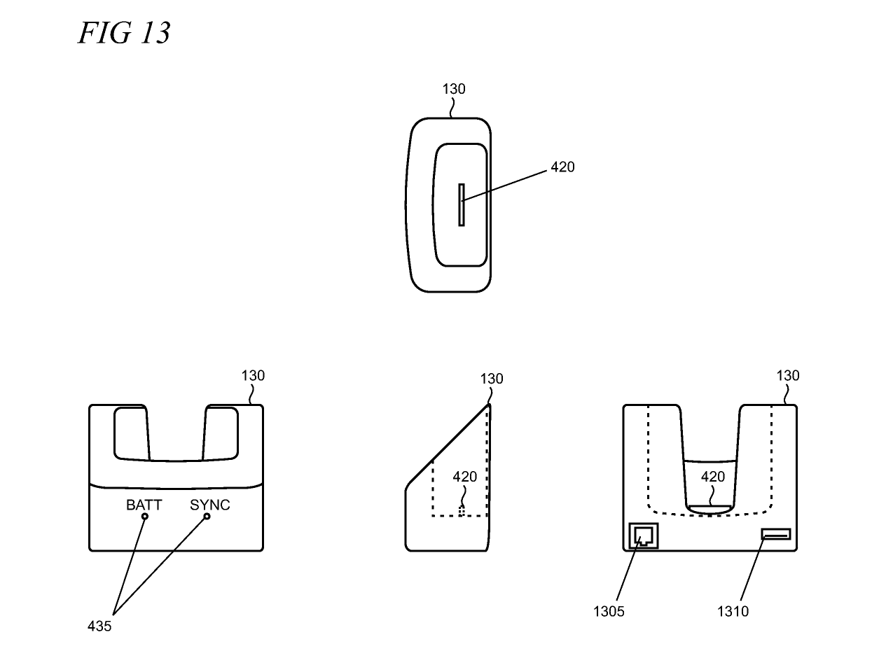

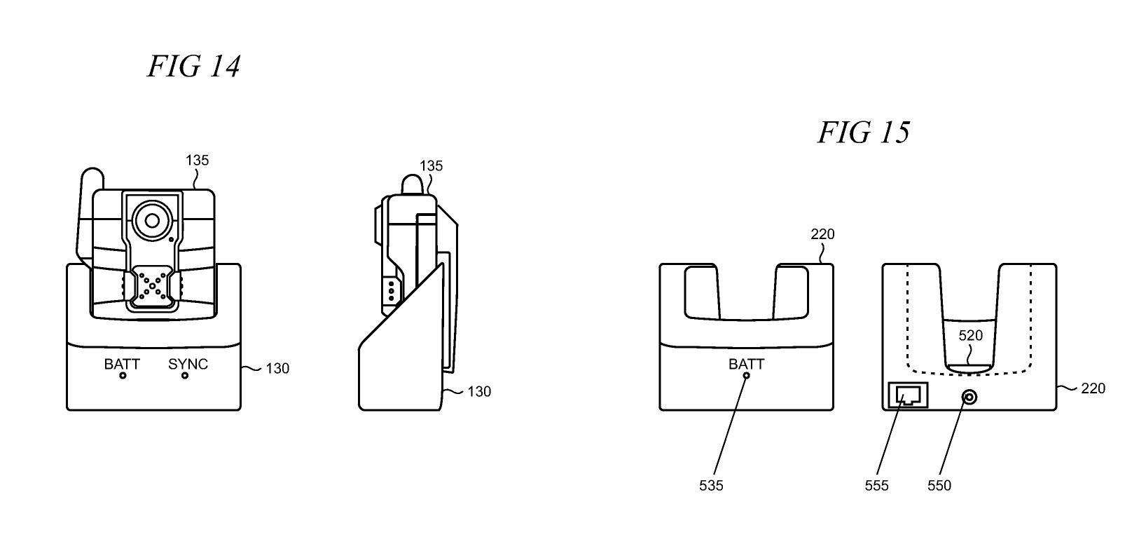

FIG. 13 shows pictorial views including front, side, back, and top views of the vehicle docking station 130. As shown, the set of LEDs 435 are located on the front of the vehicle docking station 130 to indicate charging and synchronization status of the integrated device 135 when it is docked. On the back of the vehicle docking station are an RJ12 port 1305 and a USB port 1310 which are used to provide connectivity to the bus 202 (FIG. 2) that operatively couples the vehicle docking station to the vehicle-mounted DVR 115. FIG. 14 shows front and side pictorial views of the vehicle docking station 130 when the integrated device 135 is docked. As noted above, when the integrated device 135 is docked in the vehicle docking station 130, the respective connectors 344 and 420 are mateably engaged.

FIG. 15 shows front and back pictorial views of the office docking station 220. The office docking station 220 may have a similar physical form to the vehicle docking station 130 with a few differences. As the office docking station 220 supports charging, but not synchronization as with the vehicle docking station 130, a single LED 535 may be used to indicate charging status of the battery 338 (FIG. 3). The back of the office docking station 220 includes the jack 550 for receiving 12V from an external power supply (not shown). In addition, the back of the office docking station 220 can include the RJ45 jack 555 that enables the integrated device 135 and/or camera head 305 to be coupled to an external system when docked to the office docking station. As noted above, when the integrated device 135 is docked in the office docking station 220, the respective connectors 344 and 520 are mateably engaged. Alternatively, when the camera head 305 is docked in the office docking station, the respective connectors 330 and 520 are mateably engaged.

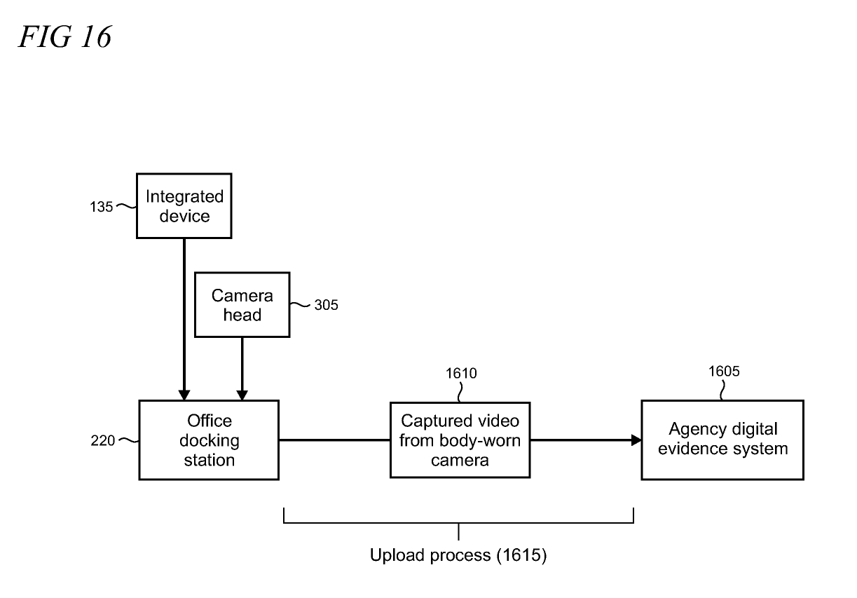

FIG. 16 shows an illustrative example of an external system. In this example, the external system comprises a digital evidence system 1605 that is operated by an agency such as a police department. The system 1605 is configured to receive and store videos 1610 that are captured by the body-worn camera 210 that may be uploaded (as indicated by reference numeral 1615) when either the camera head 305 or integrated device 135 are docked.

Based on the foregoing, it should be appreciated that technologies for integrated video and audio recording and transmission are disclosed. Although the subject matter presented herein has been described in language specific to computer structural features, methodological and transformative acts, specific computing machinery, and computer-readable storage media, it is to be understood that the invention defined in the appended claims is not necessarily limited to the specific features, acts, or media described herein. Rather, the specific features, acts, and mediums are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

What is claimed:

1. An integrated wireless microphone and body-worn camera, comprising:
a body including an area for receiving a removably attachable camera head;
a mobile transmitter disposed in the body and configured for interoperability with an in-car video system, the mobile transmitter configured for transmitting audio captured by a microphone to the in-car video system over a wireless link;
a battery disposed in the body for supply power;
a camera head including the microphone, an image sensor, and digital video recorder comprising a video processor and memory, the camera head being operatively coupled to the body when attached to the body so that power from the battery is coupled to the video processor and the microphone is coupled to the mobile transmitter.

2. The integrated wireless microphone and body-worn camera of claim 1 further including a clip on the camera head to enable the camera head to be attached to an article of clothing.

3. The integrated wireless microphone and body-worn camera of claim 1 in which the functional components are configured to interoperate with a vehicle docking station, the vehicle docking station being a component of the in-car video system.

4. The integrated wireless microphone and body-worn camera of claim 1 in which the functional components are configured to interoperate with an office docking station.

5. The integrated wireless microphone and body-worn camera of claim 1 further comprising a signal cable that operatively couples the camera head to the body when the camera head is detached from the body so that power from the battery is coupled to the video processor over the signal cable and the microphone is coupled to the mobile transmitter.

6. The integrated wireless microphone and body-worn camera of claim 1 in which the mobile transmitter includes a microcontroller and an RF (radio frequency) module.

7. The integrated wireless microphone and body-worn camera of claim 1 further comprising a user control, the user control configured to operate the body-worn camera to record video, audio and/or still images.

8. The integrated wireless microphone and body-worn camera of claim 7 in which the user control is further configured to operate a video recorder in the in-car video system.

9. A method of operating a device including an integrated wireless microphone and body-worn camera, comprising:
receiving a user-actuation of a control provided by the device;
in response to the received actuation, operating a DVR (digital video recorder) that is disposed in the device to record images captured by the body-worn camera; and
in response to the received actuation, sending audio captured by a microphone disposed in the device to an in-car video system including a vehicle-mounted DVR for recording via a wireless mobile transmitter disposed in the device.

10. The method of claim 9 further including sending a signal to the in-car video system via the wireless mobile transmitter to start a video recording by the vehicle-mounted DVR.

11. The method of claim 9 further including stopping a recording by the DVR disposed in the device in response to a user-actuation of the control while continuing to send audio captured by the microphone to the in-car video system for recording by the vehicle-mounted DVR.

12. The method of claim 9 further including enabling synchronization of the device with a vehicle docking station in the in-car video system, the synchronization comprising i) an exchange of a frequency spreading code between the in-car video system and the device or, ii) transmission of metadata including one of user name, vehicle identifier, device serial number, time/date, or a configuration file.

13. The method of claim 9 further including enabling docking of the device with an office docking station in the in-car video system, the docking providing a connection between the device and an external system for receiving recorded videos uploaded from the DVR disposed in the device.

14. The method of claim 13 in which the external system is a digital evidence system.

15. An in-car video system, comprising
a vehicle-mountable camera;
a vehicle-mountable DVR (digital video recorder) operatively coupled to the camera for recording video captured by the camera;
a vehicle docking station operatively coupled to the vehicle-mounted DVR and including a RF (radio frequency) module; and
an integrated device comprising a microphone, mobile transmitter, and body-worn camera including a small form factor DVR, the integrated device configured for i) recording video captured by the body-worn camera on the small form factor DVR and ii) wirelessly transmitting audio captured by the microphone from the mobile transmitter to the vehicle docking station for recording by the vehicle-mounted DVR.

16. The in-car video system of claim 15 further comprising an office docking station configured for providing an interface to the integrated device to a system for storing and viewing video recorded by the small form factor DVR and for charging a rechargeable battery disposed in the integrated device.

17. The in-car video system of claim 15 in which the microphone and body-worn camera are disposed in a camera head that is removably attachable to a body of the integrated device, the body housing the mobile transmitter and a rechargeable battery.

18. The in-car video system of claim 15 in which the integrated device is remotely activated using a wireless signal transmitted from the vehicle docking station so that the microphone captures audio and transmits, using the mobile transmitter, the captured audio to the vehicle docking station for recording by the vehicle-mounted DVR.

19. The in-car video system of claim 18 in which the wireless signal from the vehicle docking station is sent to the integrated device in response to an initiation of a recording by the vehicle-mounted DVR.

20. The in-car video system of claim 19 in which the initiation of a recording by the vehicle-mounted DVR is in automatic response to activation of emergency lights or siren in a vehicle in which the in-car video system is operable.
